(19) United States
(12) Patent Application Publication
(10) Pub. No.: US 2021/0186286 A1
(43) Pub. Date: Jun. 24, 2021

(54) VACUUM CLEANER

(71) Applicant: TECHTRONIC CORDLESS GP, Anderson, SC (US)

(72) Inventors: James Materdo, Charlotte, NC (US); Kirti K. Paulla, Charlotte, NC (US)

(21) Appl. No.: 17/118,988

(22) Filed: Dec. 11, 2020

Related U.S. Application Data
(60) Provisional application No. 62/951,470, filed on Dec. 20, 2019.

(51) Int. Cl. A47L 9/16

(52) U.S. Cl. CPC A47L 9/1608; A47L 9/1683; A47L 9/165

(57) ABSTRACT

A vacuum cleaner including a separator assembly that includes a first stage cyclonic separator and a clean air outlet that discharges airflow from the separator assembly. The separator assembly further includes a shroud having an air transfer portion forming an airflow passageway between a dirty air inlet and the clean air outlet and a guide wall extending from an upper end of a air transfer portion toward an upper end of a container. The dirty air inlet defines a perimeter having an upper point closest to the upper end of the container, and the guide wall is positioned substantially above the upper point. The air transfer portion is positioned substantially below the upper point, and the guide wall extends at an oblique angle relative to the separator axis.

### CROSS-REFERENCE TO RELATED APPLICATIONS

This application claims priority to U.S. Provisional Patent Application No. 62/951,470, filed Dec. 20, 2019, the entire contents of which are hereby incorporated by reference herein.

### BACKGROUND

The present invention relates to vacuum cleaners and more particularly to cyclonic vacuum cleaners.

### SUMMARY

In one embodiment, the invention provides a vacuum cleaner including a suction inlet, a suction source configured to generate an airflow through the suction inlet to draw debris with the airflow through the suction inlet, and a separator assembly downstream from the suction inlet. The separator assembly includes a container that defines a first stage cyclonic separator about a separator axis, the container having an upper end, a lower end opposite the upper end, and a dirty air inlet positioned to receive the airflow and debris to rotate around the separator axis in a first direction within the container. The separator assembly also includes a clean air outlet that discharges the airflow from the separator assembly, and a shroud located in the container. The shroud includes an air transfer portion forming an airflow passageway between the dirty air inlet and the clean air outlet and a guide wall extending from an upper end of the air transfer portion toward the upper end of the container. The dirty air inlet defines a perimeter having an upper point closest to the upper end of the container, and the guide wall is positioned substantially above the upper point. The air transfer portion is positioned substantially below the upper point, and the guide wall extends at an oblique angle relative to the separator axis.

In another embodiment, the invention provides a separator assembly for a vacuum cleaner, the separator assembly including a container that defines a first stage cyclonic separator about a separator axis, the container having an upper end, a lower end opposite the upper end, and a dirty air inlet positioned to receive an airflow and debris to rotate around the separator axis in a first direction within the container, a clean air outlet that discharges the airflow from the separator assembly, and a shroud located in the container, the shroud including a screen forming an airflow passageway between the dirty air inlet and the clean air outlet and a guide wall extending from an upper end of the screen toward the upper end of the container. The dirty air inlet defines a perimeter having an upper point closest to the upper end of the container, and the guide wall is positioned substantially above the upper point. The screen is positioned substantially below the upper point, and the guide wall extends at an oblique angle relative to the separator axis.

In another embodiment, the invention provides a vacuum cleaner including a suction inlet, a suction source configured to generate an airflow through the suction inlet to draw debris with the airflow through the suction inlet, and a separator assembly downstream from the suction inlet, the separator assembly including a container that defines a first stage cyclonic separator about a separator axis, the container having an upper end, a lower end opposite the upper end, and a dirty air inlet positioned to receive the airflow and debris to rotate around the separator axis in a first direction within the container, a clean air outlet that discharges the airflow from the separator assembly, and a shroud located in the container, the shroud including an air transfer portion forming an airflow passageway between the dirty air inlet and the clean air outlet and a guide wall extending from an upper end of the air transfer portion toward the upper end of the container. The dirty air inlet defines a perimeter having an upper point closest to the upper end of the container. The guide wall is positioned substantially above the upper point, and the guide wall is positioned substantially above the upper point. An intersection between the guide wall and the screen is substantially aligned in a radial plane with the upper point. The guide wall is configured to guide the debris toward the lower end of the container.

Other aspects of the invention will become apparent by consideration of the detailed description and accompanying drawings.

### BRIEF DESCRIPTION OF THE DRAWINGS

FIG. 1 is a perspective view of a vacuum cleaner according to an embodiment of the invention.

FIG. 2 is a cross-sectional view of a portion of the vacuum cleaner of FIG. 1.

FIG. 3 is a perspective view of a separator assembly of the vacuum cleaner of FIG. 1.

FIG. 4 is a cross-sectional view of the separator assembly of FIG. 3 taken along line 4 in FIG. 3.

FIG. 5A is a cross-sectional view of the separator assembly of FIG. 3 taken along line 5 in FIG. 3, illustrating airflow in a first cyclonic separator stage and a second cyclonic separator stage occurring in opposite directions.

FIG. 5B is a cross-sectional view of the separator assembly of FIG. 3 taken along line 5 in FIG. 3, illustrating airflow in the first cyclonic separator stage and the second cyclonic separator stage occurring in the same direction.

FIG. 6 is a cross-sectional view of the separator assembly of FIG. 3 taken along line 6 in FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

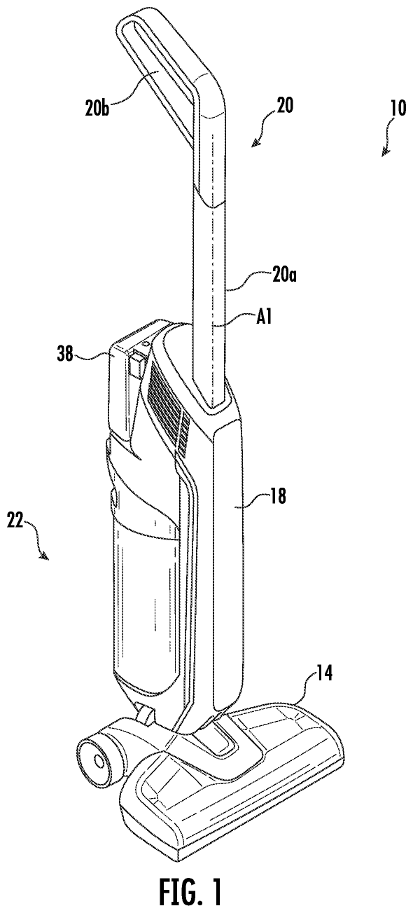

FIG. 1 illustrates a vacuum cleaner 10 according to one embodiment. The vacuum cleaner 10 includes a foot or cleaning head 14, an upright frame 18 pivotably connected to the cleaning head 14, a handle 20 having a shaft portion 20a extending from the upright frame 18 along a longitudinal axis A1 and a grip portion 20b extending from the shaft portion 20a (e.g., at an oblique angle), and a separator assembly 22 supported by the upright frame 18. As such, the illustrated vacuum cleaner 10 is an upright style vacuum cleaner. In other embodiments, however, the vacuum cleaner 10 may include other form factors (e.g., handheld, canister, etc.).

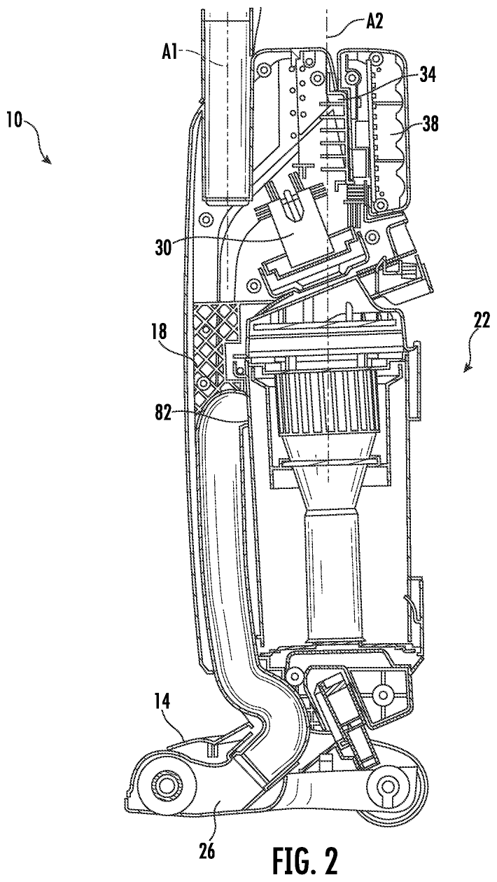

Referring to FIG. 2, the cleaning head 14 includes a suction inlet 26, and the upright frame 18 supports a suction source 30 operable to generate an airflow through the suction inlet 26 to draw debris with the airflow through the suction inlet 26. The separator assembly 22 is downstream from the suction inlet 26 and separates the debris from the airflow.

The upright frame 18 of the illustrated vacuum cleaner 10 includes a battery mount 34. A battery 38 (e.g., a rechargeable battery pack enclosing a plurality of lithium-ion battery cells or battery cells of any other suitable chemistry) is removably coupled to the battery mount 34. In some embodiments, the battery 38 may be slidably received on the battery mount 34 in a direction generally parallel to the longitudinal axis A1 of the shaft portion 20a. When the battery 38 is coupled to the battery mount 34, the battery 38 may power the vacuum cleaner 10. For example, the battery 38 may power an electric motor of the suction source 30. The battery 38 may additionally power other components, such as a brushroll motor (not shown) provided on the cleaning head 14. In other embodiments, the vacuum cleaner 10 may include a power cord to supply power to the vacuum cleaner (e.g., via a wall outlet).

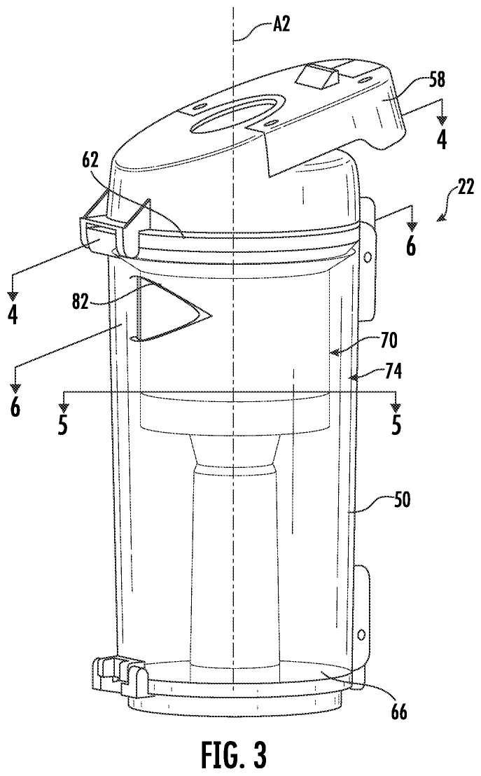

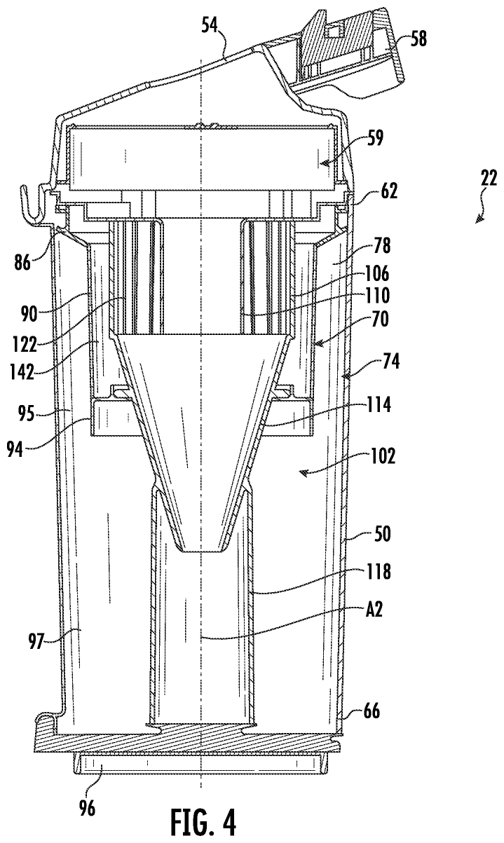

Referring to FIGS. 3-4, the illustrated separator assembly 22 includes a container 50, a clean air outlet 54 (FIG. 4), and a lid 58. The container 50 includes an upper end 62 and a lower end 66. A separator axis A2 extends centrally through the upper and lower ends 62, 66. The lid 58 is removably coupled to the upper end 62 of the container 50. The illustrated clean air outlet 54 extends through the lid 58 at an oblique angle relative to the separator axis A2. In other embodiments, the clean air outlet 54 may be positioned or oriented in other ways.

In the illustrated embodiment, a filter assembly 59 is provided on an upstream side of the clean air outlet 54 (FIG. 4). The filter assembly 59 may include one or more pleated paper filters, foam filters, mesh filters, HEPA filters, or any other suitable filter media. In some embodiments, the filter assembly 59 may be removable from the lid 58 (e.g., after removing the lid 58 from the container 50) to allow for cleaning or replacement of the filter assembly 59. In other embodiments, the filter assembly 59 may be omitted, or the filter assembly 59 may be positioned elsewhere on the vacuum cleaner (e.g., between the separator assembly 22 and the suction source 30, or downstream of the suction source 30).

With continued reference to FIGS. 3-4, the illustrated separator assembly 22 further includes a shroud 70 extending from the upper end 62 of the container 50 toward the lower end 66. In the illustrated embodiment, the shroud 70 is coupled to the lid 58 and may be removable from the container 50 together with the lid 58. In other embodiments, the shroud 70 may be fixed to the container.

The container 50 and the shroud 70 define a first stage cyclonic separator 74 about the separator axis A2. In particular, an air passage 78 is defined radially between the shroud 70 and the inner wall of the container 50 (FIG. 4). The container 50 includes a dirty air inlet 82 (FIG. 3) that is positioned to introduce the airflow and debris into the air passage 78. The first stage cyclonic separator 74 is configured to rotate the airflow and debris that enters the container 50 via the dirty air inlet 74 around the separator axis A2 within the container 50.

Referring to FIG. 4, the illustrated shroud 70 includes an upper portion 86 coupled to the lid 58, an air transfer portion 90 extending from the upper portion 86, and a skirt portion 94 extending from the air transfer portion 90. Debris separated from the airflow by the first stage cyclonic separator 74 may collect in a first dirt collection chamber 97 defined axially between the skirt portion 94 and the lower end 66 of the container 50. Specifically, a radial gap 95 between the skirt portion 94 and the interior wall of the container 50 forms a debris passageway from the first stage cyclonic separator 74 to the first dirt collection chamber 97.

In the illustrated embodiment, the lower end 66 of the container 50 is sealed by a door 96, which may be opened to facilitate emptying debris from the first dirt collection chamber 97. The illustrated door 96 is pivotally coupled to the lower end 66 of the container 50; however, the door 96 may be coupled to the container 50 in other ways.

With reference to FIG. 4, the illustrated separator assembly 22 further includes a second stage cyclonic separator 102 extending along and centered on the separator axis A2. The second stage cyclonic separator 102 includes an inlet portion 106, a vortex finder 110 at least partially disposed within the inlet portion 106, a frustoconical cyclone portion 114 extending from the inlet portion 106 toward the lower end 66 of the container 50, and a second dirt collection chamber 118 extending from the cyclone portion 114. In the illustrated embodiment, the vortex finder 110 extends the entire length of the inlet portion 106 along the separator axis A2.

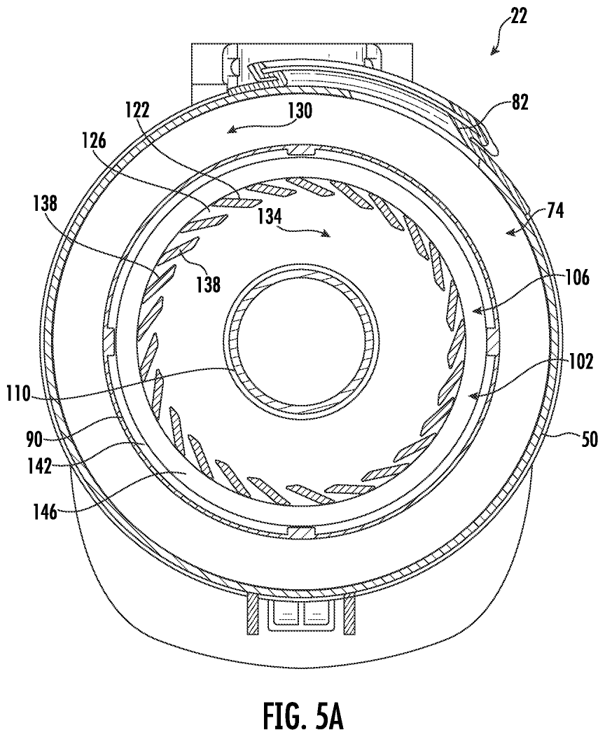

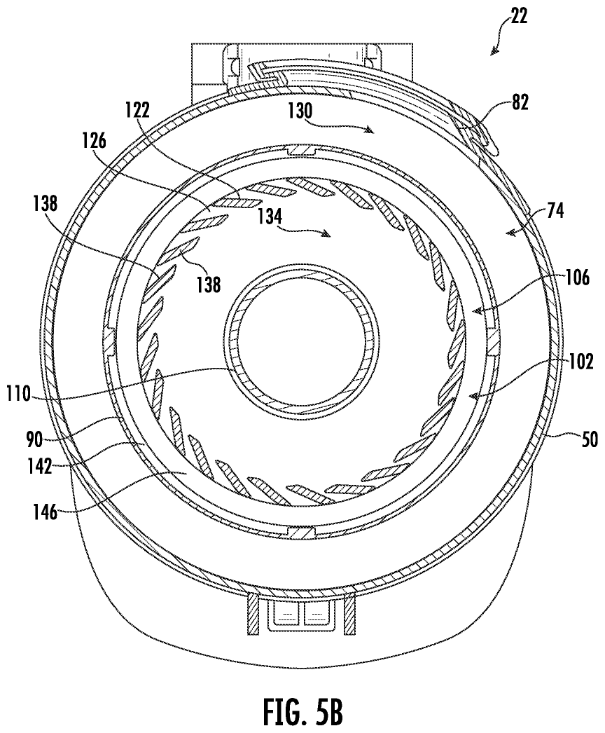

Referring to FIG. 5A, the inlet portion 106 includes a plurality of vanes 122. An airflow passage into the second stage cyclonic separator 102 is defined by openings 126 between adjacent vanes 122. In some embodiments, the first stage cyclonic separator 74 may be configured to circulate the airflow and debris in the direction of arrow 130. The openings 126 may open toward or face in a direction that is opposed to the flow direction (arrow 130) of the first stage cyclonic separator 74. As such, the openings 126 and the vanes 122 may be positioned to direct the airflow (and any debris not yet separated from the airflow) entering the second stage cyclonic separator 102 in the direction of arrow 134.

In the embodiment illustrated in FIG. 5A, the flow direction (arrow 134) through the openings 126 between the vanes 122 is at least partially opposed to the flow direction (arrow 130) in the first stage cyclonic separator 74. Thus, the airflow in the second stage cyclonic separator 102 is redirected in a generally opposite direction 134 from the flow direction 130 in the first stage cyclonic separator 74. This redirection of airflow may further help to separate the debris from the airflow and minimizes the debris that travels through the openings 126 between the vanes 122. In other embodiments, such as the embodiment illustrated in FIG. 5B, the flow direction 134 in the second stage cyclonic separator 102 is the same as the flow direction 130 in the first stage cyclonic separator 102. In such embodiments, the vanes 122 direct the airflow entering the second cyclonic separator 102 in the same direction as the flow direction 130. In either or both the embodiments of FIGS. 5A and 5B, adjacent sidewalls 138 of the vanes 122 may converge to define a gap having a decreasing area in the direction of arrow 134. This causes air to increase in speed as the air travels through the openings 126 and into the second stage cyclonic separator 102.

The airflow and remaining debris may circulate in a vortex within the second stage cyclonic separator 102 to separate the remaining debris from the air. The debris separated by the second stage cyclonic separator 102 may collect in the second dirt collection chamber 118 below the cyclone portion 114 (FIG. 4). The door 96 seals the bottom of the second dirt collection chamber 118, and the first and second dirt collection chambers 94, 118 may be emptied simultaneously by opening the door 96.

With reference to FIGS. 4 and 5A-B, the shroud 70 surrounds the inlet portion 106 of the second stage cyclonic separator 102 and may inhibit passage of debris from the first stage cyclonic separator 74 into the second stage cyclonic separator 102. In particular, the air transfer portion 90 of the shroud 70 includes a screen 142 with a plurality of openings 144 through which the airflow must pass before reaching the inlet portion 106 of the second stage cyclonic separator 102. The screen 142 extends around the separator axis A2. The screen 142 may be a perforated metal mesh with punched or etched pores. Alternatively, the screen 142 may be a wire or fiber mesh. In yet other embodiments, the screen 142 may be made of perforated plastic. In the illustrated embodiment, there is a radial gap 146 between the mesh screen 142 and vanes 122, such that the mesh screen 142 does not press directly against the vanes 122.

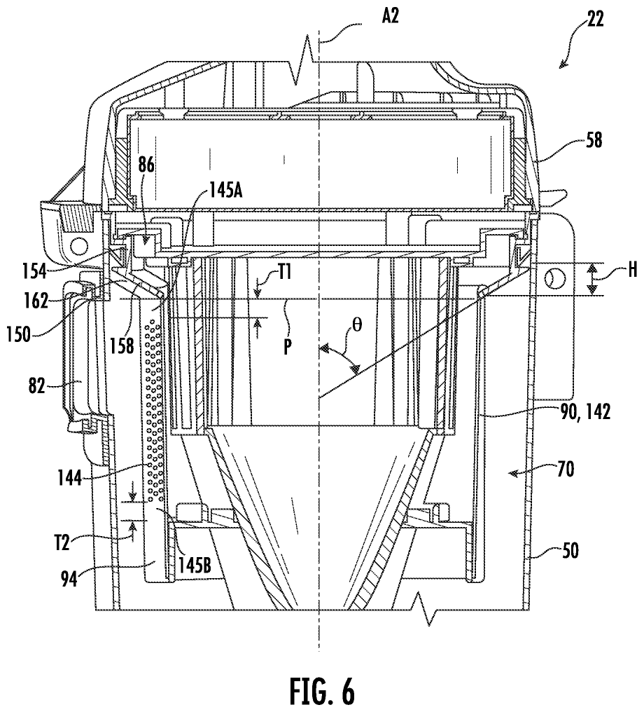

Referring to FIG. 6, the illustrated dirty air inlet 82 defines a perimeter with an upper-most point 150 (i.e. a point or area closest to the upper end 62 of the container 50). The upper portion 86 of the shroud 70 includes an attachment portion 154 coupled to the lid 58 and a transition portion 158 extending between the attachment portion 154 and the air transfer portion 90. The transition portion 158 includes a guide surface 162 that extends at an oblique angle θ relative to the separator axis A2. In some embodiments, the oblique angle θ is between 5 degrees and 85 degrees. In some embodiments, the oblique angle θ is between 30 degrees and 80 degrees. In some embodiments, the oblique angle θ is between 50 degrees and 70 degrees. In the illustrated embodiment, the oblique angle θ is about 60 degrees. In some embodiments, the guide surface 162 may be frustoconical. In the illustrated embodiment, the guide surface 162 extends radially outwardly from the air transfer portion 90, and axially toward the lid 58.

In some embodiments, the transition portion 158 may define a height H (in a direction parallel to the separator axis A2) greater than 0 millimeters, such as between 1 and 30 millimeters. In some embodiments, the height H may be between about 5 millimeters and about 30 millimeters. In some embodiments, the height H may be between about 8 millimeters and about 20 millimeters. In some embodiments, the height H may be between about 8 millimeters and about 15 millimeters. In some embodiments, the height H may be between about 8 millimeters and about 12 millimeters.

With continued reference to FIG. 6, in the illustrated embodiment, the upper-most point 150 of the dirty air inlet 82 is aligned in a radial plane P with the intersection of the transition portion 158 and the air transfer portion 90, such that all or a substantial portion of the screen 142 is below the upper-most point 150 (in a direction parallel to the separator axis A2), and all or a substantial portion of the guide surface 162 is above the upper-most point 150 (in a direction parallel to the separator axis A2).

In some embodiments, the screen 142 may not extend the entire length of the air transfer portion 90, such that the air transfer portion 90 of the shroud 70 may include one or more impermeable portions that air cannot flow through. For example, the illustrated air transfer portion 90 includes a first or upper band 145A and a second or lower band 145B. There are no openings 144 in either of the bands 145A, 145B. In the illustrated embodiment, the upper band 145A has a height T1 measured from the intersection of the transition portion 158 and the air transfer portion 90, and the lower band 145B has a height T2 measured from the intersection of the skirt 94 and the air transfer portion 90. The height T1 and the height T2 are greater than 0 millimeters, such as between about 0.5 millimeters and about 12 millimeters. In some embodiments, the height T1 and the height T2 may be between about 3 millimeters and about 12 millimeters. In some embodiments, the height T1 and the height T2 may be between about 5 millimeters and about 12 millimeters.

In some embodiments, the height T1 may be equal to the height T2, or the heights T1 and T2 may be different. In yet other embodiments, the air transfer portion 90 of the shroud 70 may include only a single impermeable band 145A or 145B. In yet other embodiments, the screen 142 may extend the entire length of the air transfer portion 90.

In operation, the vacuum cleaner 10 is used to remove debris from a surface (e.g., carpet, hard flooring, upholstery, etc.). The suction source 30 generates an airflow that draws the debris and airflow through the suction inlet 26. The airflow and debris travels into the cyclonic separator 28 through the dirty air inlet 82. Debris is separated from the airflow by the first stage cyclonic separator 74 and collected in the first dirt collection chamber 97.

The angled guide surface 162 inhibits buildup of debris adjacent the guide surface 162. For example, during operation, the airflow in the first stage cyclonic separator 74 may tend to move debris generally radially inward. The angled guide 162 surface provides a downward component to the movement of the debris, inhibiting packing and buildup of debris around the guide surface 162. In addition, because the dirty air inlet 82 is positioned entirely or substantially below the angled guide surface 162, the guide surface 162 also inhibits debris from building up around the attachment portion 154 of the shroud 70. By reducing buildup of debris, separation efficiency is improved, and it may be easier for a user to remove debris from separator assembly 22.

Providing the guide surface 162 at or above the upper point 150 of the dirty air inlet 82 may provide improved efficiency and increased capacity of the first dirt collection chamber 97 when compared with embodiments in which the guide surface 162 is positioned below the upper point 150 of the dirty air inlet 82. In such embodiments, the shroud 70 would be moved downward within the container 50, thereby reducing the height of the first dirt collection chamber 97 and reducing the separation efficiency of the first stage cyclonic separator 74. In contrast, by locating the guide surface 162 at or above the upper point 150 of the dirty air inlet 82 as illustrated in FIG. 6, the height of the first dirt collection chamber 97 is advantageously increased, leading to improved separation efficiency.

The construction and arrangement of the angled guide surface 162 relative to the dirty air inlet 82 may be particularly advantageous for compact vacuum cleaners. Increased improvements in separation efficiency were observed as air flow through the separator assembly 22 decreased. Accordingly, the embodiments of the separator assembly 22 described and/or illustrated herein may be particularly advantageous for use in a small, relatively low air power vacuum cleaner, such as some battery-powered vacuum cleaners, and particularly those with relatively short dust collection regions.

After passing through the first stage cyclonic separator 74, the airflow travels through the screen 142 in the shroud 70 that further separates debris from the airflow. After traveling through the screen 142, the airflow travels into the second stage cyclonic separator 102 through the openings 126 between the vanes 122. The redirection of the airflow by the vanes 122 (discussed above) in some embodiments may further separate debris from the airflow. The second stage cyclonic separator 102 further separates debris from the airflow, and the separated debris may fall into the second dirt collection chamber 118. The airflow then passes through the filter assembly 59 to further remove relatively fine debris from the airflow. The cleaned airflow passes through the clean air outlet 54, before being exhausted from the vacuum cleaner 10.

Various features and advantages of the invention are set forth in the following claims.

What is claimed is:

1. A vacuum cleaner comprising:
a suction inlet;
a suction source configured to generate an airflow through the suction inlet to draw debris with the airflow through the suction inlet; and
a separator assembly downstream from the suction inlet, the separator assembly including
a container that defines a first stage cyclonic separator about a separator axis, the container having an upper end, a lower end opposite the upper end, and a dirty air inlet positioned to receive the airflow and debris to rotate around the separator axis in a first direction within the container,
a clean air outlet that discharges the airflow from the separator assembly, and
a shroud located in the container, the shroud including an air transfer portion forming an airflow passageway between the dirty air inlet and the clean air outlet and a guide wall extending from an upper end of the air transfer portion toward the upper end of the container,
wherein the dirty air inlet defines a perimeter having an upper point closest to the upper end of the container,
wherein the guide wall is positioned substantially above the upper point,
wherein the air transfer portion is positioned substantially below the upper point, and
wherein the guide wall extends at an oblique angle relative to the separator axis.

2. The vacuum cleaner of claim 1, wherein the oblique angle is between 30 degrees and 80 degrees

3. The vacuum cleaner of claim 1, wherein the guide wall is configured to guide the debris toward the lower end of the container.

4. The vacuum cleaner of claim 1, wherein an intersection between the guide wall and the air transfer portion is substantially aligned in a radial plane with the upper point.

5. The vacuum cleaner of claim 1, wherein the air transfer portion includes a screen.

6. The vacuum cleaner of claim 1, wherein the guide wall as an axial height between about 5 millimeters and about 30 millimeters.

7. The vacuum cleaner of claim 1, wherein the separator assembly further includes a second cyclonic separator stage having an inlet portion, and wherein the shroud surrounds the inlet portion.

8. The vacuum cleaner of claim 7, wherein the inlet portion includes a plurality of vanes defining openings between adjacent vanes.

9. The vacuum cleaner of claim 1, wherein the shroud includes a skirt portion extending from the air transfer portion toward the lower end of the container.

10. The vacuum cleaner of claim 9, wherein the separator assembly includes a first dirt collection chamber defined between the skirt portion and the lower end of the container.

11. A separator assembly for a vacuum cleaner, the separator assembly including
a container that defines a first stage cyclonic separator about a separator axis, the container having an upper end, a lower end opposite the upper end, and a dirty air inlet positioned to receive an airflow and debris to rotate around the separator axis in a first direction within the container;
a clean air outlet that discharges the airflow from the separator assembly; and
a shroud located in the container, the shroud including a screen forming an airflow passageway between the dirty air inlet and the clean air outlet and a guide wall extending from an upper end of the screen toward the upper end of the container,
wherein the dirty air inlet defines a perimeter having an upper point closest to the upper end of the container,
wherein the guide wall is positioned substantially above the upper point,
wherein the screen is positioned substantially below the upper point, and
wherein the guide wall extends at an oblique angle relative to the separator axis.

12. The separator assembly of claim 11, wherein the oblique angle is between 30 degrees and 80 degrees.

13. The separator assembly of claim 12, wherein the shroud includes a skirt portion extending from the screen toward the lower end of the container, and wherein the separator assembly further comprises a first dirt collection chamber defined between the skirt portion and the lower end of the container.

14. The separator assembly of claim 12, wherein an intersection between the guide wall and the screen is substantially aligned in a radial plane with the upper point.

15. The separator assembly of claim 11, wherein guide wall as an axial height between about 5 millimeters and about 30 millimeters.

16. The separator assembly of claim 11, further comprising a second cyclonic separator stage having an inlet portion, and wherein the shroud surrounds the inlet portion.

17. The separator assembly of claim 16, wherein the inlet portion includes a plurality of vanes defining openings between adjacent vanes, and wherein the plurality of vanes is configured to redirect the airflow to rotate in the second cyclonic separator stage in a second direction generally opposite the first direction.

18. The separator assembly of claim 16, wherein the inlet portion includes a plurality of vanes defining openings between adjacent vanes, and wherein the plurality of vanes is configured to direct the airflow to rotate in the second cyclonic separator stage in a direction the same as the first direction.

19. A vacuum cleaner comprising:
a suction inlet;
a suction source configured to generate an airflow through the suction inlet to draw debris with the airflow through the suction inlet; and
a separator assembly downstream from the suction inlet, the separator assembly including
a container that defines a first stage cyclonic separator about a separator axis, the container having an upper end, a lower end opposite the upper end, and a dirty air inlet positioned to receive the airflow and debris to rotate around the separator axis in a first direction within the container,
a clean air outlet that discharges the airflow from the separator assembly, and
a shroud located in the container, the shroud including an air transfer portion forming an airflow passageway between the dirty air inlet and the clean air outlet and a guide wall extending from an upper end of the air transfer portion toward the upper end of the container,
wherein the dirty air inlet defines a perimeter having an upper point closest to the upper end of the container,
wherein the guide wall is positioned substantially above the upper point,
wherein an intersection between the guide wall and the screen is substantially aligned in a radial plane with the upper point, and
wherein the guide wall is configured to guide the debris toward the lower end of the container.

20. The vacuum cleaner of claim 19, further comprising a battery mount configured to receive a battery to provide power to the suction source.

21. The vacuum cleaner of claim 19,
wherein the separator assembly further includes a second cyclonic separator stage having an inlet portion, the inlet portion including a plurality of vanes defining openings between adjacent vanes,
wherein the shroud includes a skirt portion extending from the air transfer portion toward the lower end of the container, and
wherein the separator assembly further comprises a first dirt collection chamber defined between the skirt portion and the lower end of the container.

22. The vacuum cleaner of claim 21, wherein the plurality of vanes is configured to redirect the airflow to rotate in the second cyclonic separator stage in a second direction generally opposite the first direction.

23. The vacuum cleaner of claim 21, wherein the plurality of vanes is configured to direct the airflow to rotate in the second cyclonic separator stage in a direction the same as the first direction.
